(19) United States
(12) Patent Application Publication
(10) Pub. No.: US 2016/0148135 A1
(43) Pub. Date: May 26, 2016

(54) SYSTEMS AND METHODS FOR BALANCING AN ASSEMBLY LINE

(71) Applicant: Caterpillar Inc., Peoria, IL (US)

(72) Inventors: Joseph R. HERRON, Farmington, IL (US); Yamin Z. MOHAMMED, Peoria, IL (US)

(73) Assignee: Caterpillar Inc., Peoria, IL (US)

(21) Appl. No.: 14/550,301

(22) Filed: Nov. 21, 2014

(51) Int. Cl. G06Q 10/06

(52) U.S. Cl. CPC G06Q 10/06312

(57) ABSTRACT

Systems and methods are disclosed for balancing an assembly line. According to certain embodiments, a plurality of routings is received. A plurality of fields is extracted from each of the plurality of routings. A line balancing report may be generated based on the extracted fields.

### TECHNICAL FIELD

The present disclosure generally relates to systems and methods for balancing an assembly line and, more particularly, to systems and methods for balancing an assembly line based on configured production orders.

### BACKGROUND

In order to ensure that production meets demand, manufacturers monitor the efficiency of their manufacturing processes and adjust the processes as necessary. One way that manufacturers adjust their processes is assembly line balancing. To balance an assembly line, a manufacturer may observe the time it takes assemblers to perform various assembly tasks and make adjustments to the tasks assigned to assemblers based on observed inefficiencies. For example, if a manufacturer observes that certain tasks demand more time of their assigned assemblers to complete, the manufacturer may assign additional assemblers to those tasks or assign a more experienced assembler to the more difficult tasks.

Current systems for assembly line balancing are based on estimated production orders or personal observation (e.g., monitoring of assemblers by supervisors). While these systems help make processes more efficient on a process-by process (or machine-by-machine) basis, they do not adequately account for changes in the manufacturing process or the customization of specific machines being assembled. Rather, these systems balance the assembly line based on current observations and estimated needs.

One technique for distributing work among human resources is described in U.S. Patent App. Pub. No. 2004/0010437 (“the '437 application”). The '437 application discloses updating human resource availability, forecasting human resource workload for a specified time period, determining understaffed time periods, and scheduling non-pooled human resources. According to the '437 application, the disclosed techniques enable managers effectively to share human resources across multiple locations on a day-to-day basis.

Although the techniques for distributing work disclosed in the '437 application may have general applicability for sharing human resources among different groups of an organization, these techniques do not account for specific needs of manufacturers. For example, the '437 application does not associate human resources with specific manufacturing processes, such as models or orders. Moreover, the '437 application does not forecast need for human resources based on specific products that have been ordered from the manufacturer or manually configured but unreleased production orders to be built in the future.

The present disclosure is directed to overcoming one or more of the problems set forth above and/or other problems in the art.

### SUMMARY OF THE INVENTION

In one aspect, the present disclosure is directed to a system for balancing an assembly line, including a memory that stores a set of instructions and at least one processor in communication with the memory and configured to execute the set of instructions to perform certain steps. The at least one processor is configured to receive a plurality of routings. The at least one processor is further configured to extract a plurality of fields from each of the plurality of routings. Additionally, the at least one processor is configured to generate a line balancing report based on the extracted fields.

In another aspect, the present disclosure is directed to a non-transitory computer-readable storage medium storing instructions for balancing an assembly line. The instructions cause the at least one processor to perform operations including receiving a plurality of routings. The operations further include extracting a plurality of fields from each of the plurality of routings. Further, the operations include generating a line balancing report based on the extracted fields.

### BRIEF DESCRIPTION OF THE DRAWINGS

FIG. 1 is an illustration of an exemplary system environment for balancing an assembly line; and

FIG. 2 is a flow chart illustrating an exemplary disclosed method of balancing an assembly line.

### DETAILED DESCRIPTION

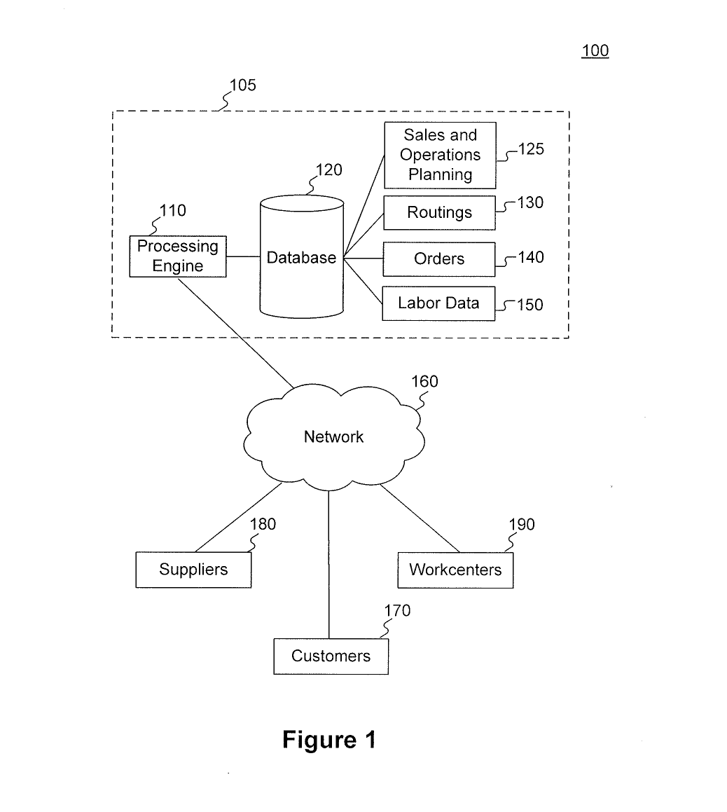

FIG. 1 depicts an exemplary system environment 100 for balancing an assembly line. As shown in FIG. 1, system environment 100 includes a number of components. It will be appreciated from this disclosure that the number and arrangement of these components is exemplary and provided for purposes of illustration. Other arrangements and numbers of components may be utilized without departing from the teachings and embodiments of the present disclosure.

As shown in FIG. 1, the exemplary system environment 100 includes a system 105. System 105 may include one or more server systems, databases, and/or computing systems configured to receive information from entities over a network and process and/or store the information. In one embodiment, system 105 may include a processing engine 110 and one or more databases 120, which are illustrated in a region bounded by a dashed line for system 105 in FIG. 1.

In one embodiment, system 105 may transmit and/or receive data to/from various other components of system environment 100, such as one or more customers 170, suppliers 180, and workcenters 190. More specifically, system 105 may be configured to receive and store data transmitted over an electronic network 160 (e.g., comprising the Internet) from various data sources, including customers 170, suppliers 180, and workcenters 190, process and/or store the received data, and transmit the processed data over the electronic network to consumers of the data, which may include customers 170, suppliers 180, and workcenters 190, among others.

The various components of system environment 100 may include an assembly of hardware, software, and/or firmware, including a memory, a central processing unit (“CPU”), and/or a user interface. Memory may include any type of RAM or ROM embodied in a non-transitory computer-readable storage medium, such as magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. Singular terms, such as “memory” and “computer-readable storage medium,” may additionally refer to multiple structures, such as a plurality of memories and/or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals. A CPU may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

As described above, system 105 may be configured to receive data over electronic network 160 and store the data. System 105 may receive data over electronic network 160 from customers 170. For example, system 105 may receive orders from customers 170 for products produced by a manufacturer, including model name, customizations (e.g., non-standard attachments), quantity, order date, and requirement date.

System 105 may also receive data over electronic network 160 from suppliers 180, which may supply components of one or more manufacturing processes. For example, system 105 may receive information from suppliers 180 regarding components available for purchase from supplier 180, including component identifier, cost, lead time (i.e., expected time it takes to ship the component calculated from order date), and inventory (i.e., number of components currently available).

Further, system 105 may receive data over electronic network 160 from workcenters 190. Workcenters 190 may represent physical or logical subdivisions within one or more manufacturing facilities that are responsible for one or more stages of an assembly process. System 105 may receive information from workcenters 190 regarding the assembly of one or more machines, such as necessary parts (e.g., bill of materials (BOM)), current inventory, demand, routings, labor information (e.g., days assemblers are available to work on an assembly), and workcenter responsibilities (e.g., a description of a workcenter's responsibilities with respect to an assembly).

In one embodiment, system 105 may store data received over electronic network 160 from customers 170, suppliers 180, workcenters 190, and other sources in one or more databases 120. In an alternate embodiment, system 105 may store data received over electronic network 160 from customers 170, suppliers 180, workcenters 190, and other sources in other memory associated with processing engine 110, including a local memory of processing engine 110 or remote storage (e.g., a remote server in communication with processing engine 110 (not shown)). Database 120 may be any suitable combination of large scale data storage devices, which may optionally include any type or combination of slave databases, load balancers, dummy servers, firewalls, back-up databases, and/or any other desired database components. For example, processing engine may receive order information from customers 170 and store this information in database 120. Processing engine 110 may receive information regarding the cost, inventory, and lead time for components from suppliers 180 and store this information in database 120. Processing engine 110 may receive information regarding the assembly process, such as necessary components, inventory, demand, routings, labor information, and workcenter responsibilities, from workcenters 190 and store this information in database 120.

Processing engine 110 may further associate the information received from customers 170, suppliers 180, and workcenters 190 with various tables or components of database 120, such as sales and operations planning 125, routings 130, orders 140, and labor data 150. For example, processing engine 110 may associate routing information received from workcenters 190 with routings 130 and labor information received from workcenters 190 with labor data 150. Processing engine may associate orders received from customers 170 with orders 140.

According to certain embodiments, database 120 stores sales and operations planning 125, routings 130, orders 140, and labor data 150. This information is used by system 105 to balance an assembly line, according to one or more of the embodiments disclosed herein.

Sales and operations planning (S&OP) 125 provides a projected build rate per sales model. For example, S&OP 125 may specify that one tractor must be produced per day in order to meet demand. This information may be used to determine the rate at which individual components within the tractor must be produced to meet demand for the tractor.

Routings 130 may include one or more routings associated with one or more models produced by a manufacturer. In one embodiment, each routing includes a sequence of events associated with the assembly of a model. For example, a routing for a Model 1 Tractor may include a sequence of events associated with the assembly of the Model 1 Tractor, such as assembly of the engine, assembly of the frame, etc. A routing may include a variety of fields, such as subprocess, arrangement, operation identifier, operation find number (e.g., sequence number), operation description, labor time, area identifier, mechanical class (e.g., assembler), workcenter, order number, model, start date of production, and model order.

Routings 130 may include several types of routings, such as master routings, routings for configured production orders, and routings that have been manually configured but not released for production build. A master routing includes a sequence of events corresponding to all possible combinations of attachments that may be included in a model. The routing for a configured production order may include a sequence of events for assembling a model based on the requirements of that model set forth in a configured production order. In other words, the routing for a configured production order describes how to assemble a specific model that has been ordered by a customer 170, including any customizations that the customer 170 has requested. The configured production order may also correspond to a set of customizations that have been manually entered to produce a configured order, without having received a request for the order from a customer.

Orders 140 may include orders received from customers 170 for products produced by a manufacturer. As discussed above, orders for specific machines, including any customizations to a model, may be referred to as configured production orders. Each order may include a variety of information, such as model number, attachments or customizations, number of units requested, order date, and requirement date (e.g., the time by which the machine described in the order must be ready for delivery to the customer). Order information may be used to determine a takt time for assembly of the machine described in the order. Takt time describes an amount of time allowed for assembly of a unit in order to meet a demand for a machine. Accordingly, takt time for a customized production order may be determined based on the routing for the order (e.g., how to make the order), the number of final machines requested by the order, and the requirement date for the order. Further, data from S&OP 125 may be used to determine takt time. For example, a projected build rate per sales model may be used to determine a takt time for the model.

Labor data 150 may include information that describes the ability of a manufacturer's human resources to perform work. For example, labor data 150 may include planned time, operation description, workcenter, sales model, production order, mechanism class, area/section/value stream, operation identifier, start date of production, and attachments. Labor data 150 may also associate assemblers with workcenters 190, attachments, and models.

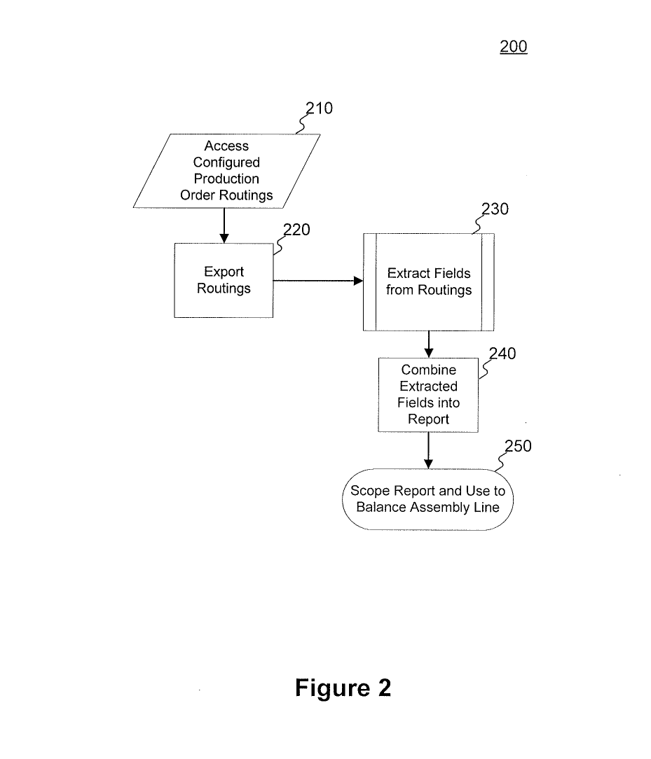

In accordance with certain embodiments, processing engine 110 may receive a plurality of routings. For example, processing engine 110 may receive a plurality of routings associated with configured production orders. A plurality of fields, such as production order, assembler, and labor time, may be extracted from each routing. A line balancing report is generated based on the extracted fields. FIG. 2, discussed below, provides further detail regarding techniques for balancing an assembly line process.

### INDUSTRIAL APPLICABILITY

The disclosed systems and methods for balancing an assembly line may be utilized to improve efficiency of assembly processes. In particular, the disclosed systems and methods enable manufacturers to balance work among assemblers based on configured production orders or manually configured orders that have not been released to production. By optimizing the distribution of work among assemblers, manufacturers are better able to meet demand. Whereas prior methods for balancing an assembly line were based on estimated production orders or personal observation, the disclosed systems and methods distribute work among assemblers based on routings for configured production orders received by a manufacturer from its customers.

FIG. 2 depicts an exemplary flow of a process 200 for balancing an assembly line, in accordance with an embodiment of the present disclosure. The steps associated with this exemplary process may be performed by the components of FIG. 1. For example, the steps associated with the exemplary process of FIG. 2 may be performed by processing engine 110 and/or database 120 of system 105 illustrated in FIG. 1.

In step 210, processing engine 110 may access configured production order routings. For example, processing engine 110 may access a database containing routings for configured production orders received from customers. Each routing may include a sequence of events for assembling a machine described by a configured production order. Processing engine 110 may export these routings at step 220. In one embodiment, configured production order routings accessed in step 210 may be exported to a master file (e.g., a spreadsheet) and stored by processing engine 110 in local or remote storage.

In step 230, processing engine 110 extracts a subset of fields from the routings. In one embodiment, the subset of fields is extracted from the master file generated as a result of step 220. These may include a variety of fields containing information that may be used to determine how to distribute work among assemblers on an assembly line. In one embodiment, processing engine 110 extracts the following information from the master file: subprocess, arrangement, operation identifier, operation find number (e.g., sequence number), operation description, labor time, area identifier, mechanism class (e.g., assembler), workcenter, order number, model, start date of production, and model order.

Processing engine 110 combines the extracted fields to generate a report in step 240. More specifically, processing engine 110 may generate a line balancing report based on the extracted fields. The generated report may provide, for each configured production order, a labor time associated with each assembler involved in the assembly of a machine associated with the configured production order, as well as a total labor time for all assemblers involved in the assembly of the machine. The generated report may also indicate the total labor time assigned to each assembler across all production orders. Further, the generated report may indicate the minimum, maximum, and average labor time that assemblers (individually and/or collectively) spend on configured production orders.

In step 250, processing engine 110 may scope the report and use it to balance an assembly line. For example, processing engine 110 may scope the report based on a workcenter, such that the work performed by the workcenter may be balanced appropriately among the assemblers associated with that workcenter. Several parameters may be set to define the scope of the generated report, including workcenter, start date of production, subprocess, and model. Further, each parameter may correspond to multiple values (e.g., two subprocesses or three models) or all values (e.g., all start dates of production).

In addition to scoping the report based on one or more factors, processing engine 110 may also set parameters for the report, such as takt time and number of assemblers. In one embodiment, processing engine 110 may set a takt time representing an amount of time allowed for assembly of a unit in order to meet a demand for a machine. The takt time may be determined based on the projected build rate per sales model received from S&OP 125, as discussed above. Processing engine 110 may use the takt time to determine how to appropriately allocate assembly tasks among assemblers to meet demand. In one embodiment, processing engine 110 may set a number of assemblers available for work on the configured production orders. Thus, processing engine 110 may assign different amounts of work and allocate higher/lower labor times to each assembler based on the number of assemblers available to work on the configured production orders.

By scoping the line balancing report based on workcenter, start date of production, subprocess, model, and/or other factors, a manufacturer can more easily understand the distribution of work among assemblers involved in the production of one or more machines. Moreover, by running the line balancing report based on certain parameters, such as takt time and number of assemblers, the manufacturer can assess the impact of raising or lowering the number of assemblers assigned to a process or the amount of time each assembler is allotted to perform work on an assembly. Thus, manufacturers may utilize the line balancing report to determine how to distribute work among assemblers to meet deadlines for delivery of configured production orders.

In another exemplary process for balancing an assembly line, a plurality of routings is received. In one embodiment, each of the plurality of routings is associated with a configured production order, which identifies each component used in the assembly of a machine. Moreover, each configured production order may be associated with an assembly that has been completed within the past month, is in progress, or has not yet begun. Thus, the plurality of routings received may describe how to assemble recently ordered machines, as reflected in configured production orders associated with assemblies that are yet to be completed or those that have recently been completed.

A plurality of fields may be extracted from each of the plurality of routings. In one embodiment, the extracted fields include production order, assembler, and labor time. In other embodiments, additional fields, such as subprocess, arrangement, operation identifier, operation find number (e.g., sequence number), operation description, area identifier, workcenter, model, start date of production, and model order, may also be extracted from each of the plurality of routings.

A line balancing report may be generated based on the extracted fields. In one embodiment, the generated report indicates a labor time of each assembler associated with a production order. A takt time may also be received and included in the line balancing report. Moreover, the generated line balancing report may be scoped based on a workcenter. The generated line balancing report may also be scoped based on other factors, such as start date of production, subprocess, and model, as discussed above.

Based on the generated line balancing report, work may be distributed to one or more assemblers. In one embodiment, a labor time associated with at least one of the plurality of routings may be updated.

Several advantages over the prior art may be associated with the disclosed systems and methods for balancing an assembly line. Unlike the techniques described in the prior art, the disclosed techniques enable manufacturers to balance an assembly line based on configured production orders. This enables manufacturers to determine how to distribute work among assemblers in light of current demand for products.

It will be apparent to those skilled in the art that various modifications and variations can be made to the disclosed systems and methods for balancing an assembly line. Other embodiments will be apparent to those skilled in the art from consideration of the specification and practice of the disclosed systems and methods for balancing an assembly line. It is intended that the specification and examples be considered as exemplary only, with a true scope being indicated by the following claims and their equivalents.

What is claimed is:

1. A system for balancing an assembly line, comprising:
a memory that stores a set of instructions; and
at least one processor in communication with the memory and configured to execute the set of instructions to:
receive a plurality of routings;
extract a plurality of fields from each of the plurality of routings; and
generate a line balancing report based on the extracted fields.

2. The system of claim 1, wherein each of the plurality of routings is associated with a configured production order.

3. The system of claim 2, wherein the configured production order identifies each component used in the assembly of a machine.

4. The system of claim 2, wherein the configured production order is associated with an assembly that has been completed within the past month, is in progress, or has not yet begun.

5. The system of claim 1, wherein the extracted fields include production order, assembler, and labor time.

6. The system of claim 5, wherein the generated line balancing report indicates a labor time of each assembler associated with a production order.

7. The system of claim 1, wherein the at least one processor is further configured to:
receive a takt time, wherein the takt time describes an amount of time allowed for assembly of a unit in order to meet a demand for a machine, and
wherein the generated line balancing report includes the takt time.

8. The system of claim 1, wherein the at least one processor is further configured to scope the generated line balancing report based on a workcenter.

9. The system of claim 1, wherein the at least one processor is further configured to distribute work to one or more assemblers based on the generated line balancing report.

10. The system of claim 1, wherein the at least one processor is further configured to update a labor time associated with at least one of the plurality of routings.

11. A non-transitory computer-readable storage medium storing instructions for balancing an assembly line, the instructions causing at least one processor to perform operations comprising:
receiving a plurality of routings;
extracting a plurality of fields from each of the plurality of routings; and
generating a line balancing report based on the extracted fields.

12. The non-transitory computer-readable storage medium of claim 11, wherein each of the plurality of routings is associated with a configured production order.

13. The non-transitory computer-readable storage medium of claim 12, wherein the configured production order identifies each component used in the assembly of a machine.

14. The non-transitory computer-readable storage medium of claim 12, wherein the configured production order is associated with an assembly that has been completed within the past month, is in progress, or has not yet begun.

15. The non-transitory computer-readable storage medium of claim 11, wherein the extracted fields include production order, assembler, and labor time.

16. The non-transitory computer-readable storage medium of claim 15, wherein the generated line balancing report indicates a labor time of each assembler associated with a production order.

17. The non-transitory computer-readable storage medium of claim 11, wherein the instructions cause the at least one processor to:
receive a takt time, wherein the takt time describes an amount of time allowed for assembly of a unit in order to meet a demand for a machine, and
wherein the generated line balancing report includes the takt time.

18. The non-transitory computer-readable storage medium of claim 11, wherein the instructions cause the at least one processor to scope the generated line balancing report based on a workcenter.

19. The non-transitory computer-readable storage medium of claim 11, wherein the instructions cause the at least one processor to distribute work to one or more assemblers based on the generated line balancing report.

20. The non-transitory computer-readable storage medium of claim 11, wherein the instructions cause the at least one processor to update a labor time associated with at least one of the plurality of routings.
